(19) United States
(12) Patent Application Publication
(10) Pub. No.: US 2026/0056994 A1
(43) Pub. Date: Feb. 26, 2026

(54) MACHINE LEARNING BASED QUERY PROCESSING TECHNIQUES

(71) Applicant: ModernaTX, Inc., Cambridge, MA (US)

(72) Inventors: Rebecca Vislay-Wade, Malden, MA (US); Srinivasan Varadarajan, Boston, MA (US); Bodhisatwa Mukhopadhyay, Cambridge, MA (US); Braja Krishna Das, Bothell, WA (US); Swapnil Joshi, Bellevue, WA (US)

(73) Assignee: ModernaTX, Inc., Cambridge, MA (US)

(21) Appl. No.: 19/300,006

(22) Filed: Aug. 14, 2025

Related U.S. Application Data
(60) Provisional application No. 63/687,207, filed on Aug. 26, 2024.

(51) Int. Cl. G06F 16/334

(52) U.S. Cl. CPC G06F 16/334

(57) ABSTRACT

Some embodiments relate to a system for processing queries. The system identifies, from among document portions stored in at least one database, at least one document portion to use for responding to request(s) in a query. The system generates, using a generative machine learning (ML) model and the identified document portion(s), a response to the request(s) at least in part by: generating a prompt for the generative ML model using the identified document portion(s); and providing the prompt to the generative ML model to generate the response to the request(s).

### RELATED APPLICATIONS

This application claims the benefit under 35 U.S.C. § 119(e) of U.S. Provisional Application No. 63/687,207 titled “MACHINE LEARNING BASED QUERY PROCESSING TECHNIQUES,” filed on Aug. 26, 2024, which is incorporated by reference herein.

### FIELD

Aspects of the present disclosure relate to techniques for processing queries. In particular, the techniques use retrieval augmented generation (RAG) to automate processing of queries received from a health authority.

### BACKGROUND

A pharmaceutical company may interact frequently with one or more health authorities. For example, the pharmaceutical company may interact with a health authority during drug development or during an application for marketing authorization of a drug. The health authority may pose questions to the pharmaceutical company as part of its process of reviewing an application associated with a drug. The pharmaceutical company may be required to respond to a question posed by a health authority within a designated timeframe. The response to the question may require research, coordination, collection of documentation, and/or other steps. The health authority may review answers to the question submitted by the pharmaceutical company.

### SUMMARY

Some embodiments provide method for processing healthy authority queries received from a health authority system. The method comprises using at least one computer hardware processor of a data processing system to perform: (A) receiving a query through a communication channel, the query comprising text indicating at least one request; (B) identifying, from among document portions stored in at least one database, at least one document portion to use for responding to the at least one request, the identifying comprising: generating a numeric representation of the text in the query indicating the at least one request; identifying the at least one document portion by comparing the numeric representation of the text with respective numeric representations of document portions stored in the at least one database; and (C) generating, using a generative machine learning (ML) model and the identified at least one document portion, a response to the at least one request at least in part by: generating a prompt for the generative ML model using the identified at least one document portion; and providing the prompt to the generative (ML) model to generate the response to the at least one request.

Some embodiments provide a system for processing healthy authority queries received from a healthy authority system. The system comprises at least one computer hardware processor and at least one non-transitory computer-readable storage medium storing instructions that, when executed by the at least one computer hardware processor, cause the at least one computer hardware processor to perform: (A) receiving a query through a communication channel, the query comprising text indicating at least one request; (B) identifying, from among document portions stored in at least one database, at least one document portion to use for responding to the at least one request, the identifying comprising: generating a numeric representation of the text in the query indicating the at least one request; identifying the at least one document portion by comparing the numeric representation of the text with respective numeric representations of document portions stored in the at least one database; and (C) generating, using a generative machine learning (ML) model and the identified at least one document portion, a response to the at least one request at least in part by: generating a prompt for the generative ML model using the identified at least one document portion; and providing the prompt to the generative (ML) model to generate the response to the at least one request.

Some embodiments provide at least one non-transitory computer-readable storage medium storing instructions that, when executed by the at least one computer hardware processor, cause the at least one computer hardware processor to perform a method for processing healthy authority queries received from a health authority system. The method comprises: (A) receiving a query through a communication channel, the query comprising text indicating at least one request; (B) identifying, from among document portions stored in at least one database, at least one document portion to use for responding to the at least one request, the identifying comprising: generating a numeric representation of the text in the query indicating the at least one request; identifying the at least one document portion by comparing the numeric representation of the text with respective numeric representations of document portions stored in the at least one database; and (C) generating, using a generative machine learning (ML) model and the identified at least one document portion, a response to the at least one request at least in part by: generating a prompt for the generative ML model using the identified at least one document portion; and providing the prompt to the generative (ML) model to generate the response to the at least one request.

The foregoing is a non-limiting summary.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A illustrates an example interaction between a data processing system and a health authority system, according to some embodiments of the technology described herein.

FIG. 1B illustrates example components of the data processing system of FIG. 1A, according to some embodiments of the technology described herein.

FIG. 1C illustrates processing of a query performed by the data processing system of FIGS. 1A-1B, according to some embodiments of the technology described herein.

FIG. 1D illustrates generation of a response to a request in a query by the data processing system of FIGS. 1A-1B using a generative machine learning (ML) model, according to some embodiments of the technology described herein.

FIG. 2A illustrates generation of numeric representations of documents, according to some embodiments of the technology described herein.

FIG. 2B illustrates dividing of documents into portions and generation of numeric representations corresponding to the document portions, according to some embodiments of the technology described herein.

FIG. 3 illustrates an example identification of document portions to use for generating a response to a request in a query, according to some embodiments of the technology described herein.

FIG. 4 illustrates an example process of processing queries received from a health authority system, according to some embodiments of the technology described herein.

FIG. 5 is a block diagram of an illustrative computing system that may be used in implementing some embodiments of the technology described herein.

### DETAILED DESCRIPTION

Described herein are techniques of processing queries received from a health authority system to generate responses to the queries. For example, the techniques may be used to process electronically received queries from a health authority system as part of a drug application submitted by a pharmaceutical company. The techniques enable the use of machine learning technology to generate query responses.

An organization (e.g., a pharmaceutical company, a corporation, or other organization) may electronically receive queries for information from other systems. To illustrate, a pharmaceutical company may receive queries from a health authority. For example, during a process of bringing a new drug to market, the pharmaceutical company may receive multiple queries from a health authority (e.g., the Food and Drug Administration (FDA)) reviewing an application (e.g., a new drug application, an investigational new drug application, or other application) associated with the drug. The queries may include requests for information regarding the drug and/or the application (e.g., clinical result data, laboratory data, and/or other information). The pharmaceutical company may be required to respond to the health authority queries (HAQs) for the application associated with the drug to advance in a review process.

Conventionally, techniques used by organizations in responding to queries rely heavily on human users to generate responses to the requests. A user would typically be required to read queries and identify the appropriate subject matter experts (SMEs) to provide responses to the requests. These SMEs would need to determine responses to the requests by reviewing the requests, authoring text of the responses, and organizing the responses into specifically formatted documents for storage in a database (e.g., a regulatory information management (RIM) database).

The inventors have recognized that conventional query processing technology is unable to efficiently process received queries. An organization may receive thousands of queries that need to be processed to generate corresponding responses. The efficiency of processing the queries is limited by the number of human users available to review queries and/or the extent to which processes performed by the human users can be automated. For example, a pharmaceutical company may receive hundreds or thousands of HAQs (e.g., from the FDA) in connection with multiple different drug applications being reviewed by the health authority. Each of these HAQs needs to be reviewed by a subject matter expert, who must then author a response to the HAQ. This inefficiency in processing queries delays performance of clinical trials, development of treatments, and administration of the treatments to the population.

One technology that could be used to improve the efficiency of processing HAQs is generative ML technology. A generative ML model may be prompted to generate responses to requests in the HAQs. However, a generative ML model would be unable to accurately generate responses to requests from HAQs because it cannot produce the necessary information that may need to be included in the responses. For example, a request regarding a new drug application may require information about a specific application submitted to the FDA, data collected from testing involving the new drug, background information about the new drug, and/or other information. A generative ML model would be unable to produce this information, and thus would be unable to accurately respond to the request regarding the new drug application.

Accordingly, the inventors have developed a new approach to processing HAQs that enables the use of a generative ML model in generating responses to requests in queries. The inventors have developed techniques that (1) use retrieval augmented generation (RAG) techniques to automatically identify documents stored in one or more databases that are relevant to a given HAQ; and (2) use the relevant documents to generate a response to the HAQ with a generative ML model. The relevant documents provide the generative ML model with contextual data needed to generate an accurate response to a request in a query. The generative ML model may be prompted to generate a response to a request by providing relevant document(s) from the database(s) as context with a prompt.

Techniques described herein encode portions of documents into respective numeric representations that can be efficiently searched to identify document portions that are relevant to a request. When a query is received, a query processing system encodes text from the query into a numeric representation. The system uses the numeric representation of the query text to search for relevant documents by comparing the numeric representation of the query text to numeric representations of document portions. Numeric representations that are most similar (e.g., based on a numerical measure of similarity) to the numerical representation of the query text may be recognized by the system as representing document portions that may be useful in generating a response to the query. The system accesses the document portions associated with the numeric representations that most closely match the numeric representation of the query text and uses the document portions to generate a response to the query.

Some embodiments provide a system for processing queries (e.g., HAQs) from a health authority system. The system receives a query through a communication channel (e.g., email). The query includes text that indicates one or more requests (e.g., question(s), request(s) for information, and/or other request(s)). The system identifies, from among document portions stored in database(s), document portion(s) to use for responding to the request(s). The system identifies the document portion(s) by: (1) generating a numeric representation (e.g., a numerical vector) of the text in the query that indicates the request(s); and (2) identifying the document portion(s) by comparing the numeric representation of the text with respective numeric representations of document portions stored in the database(s) (e.g., by determining a measure of distance between the numeric representations). The system generates a response to the request(s) using a generative ML model and the identified document portion(s) by: (1) generating a prompt for the generative ML model using the identified document portion(s) (e.g., by including the document portion(s) as context for generating a response; and (2) providing the prompt to the generative ML model to generate the response to the request(s).

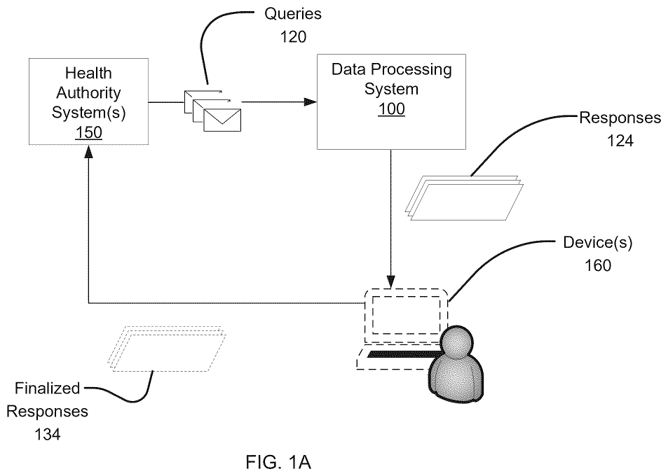

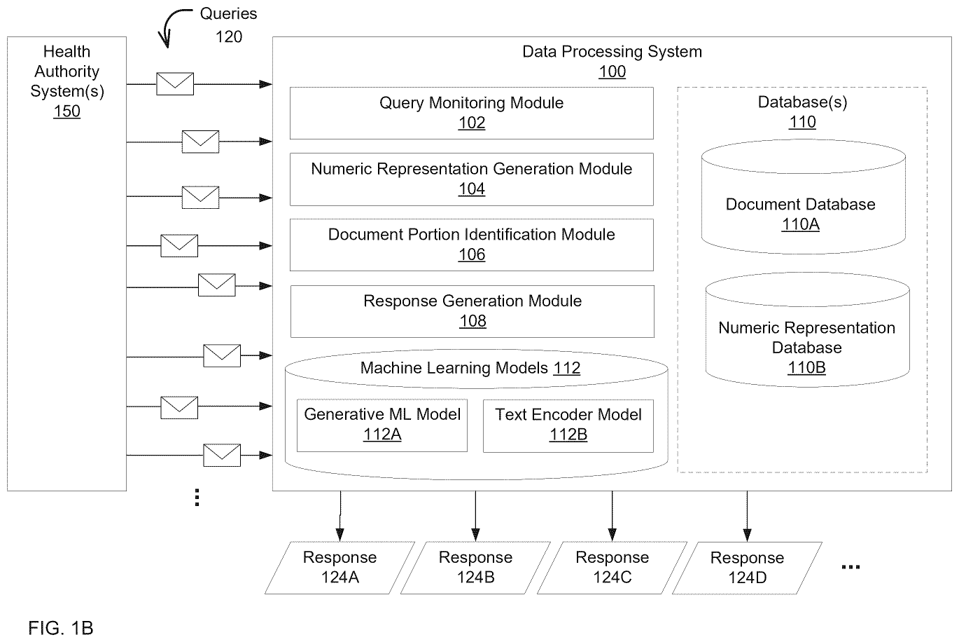

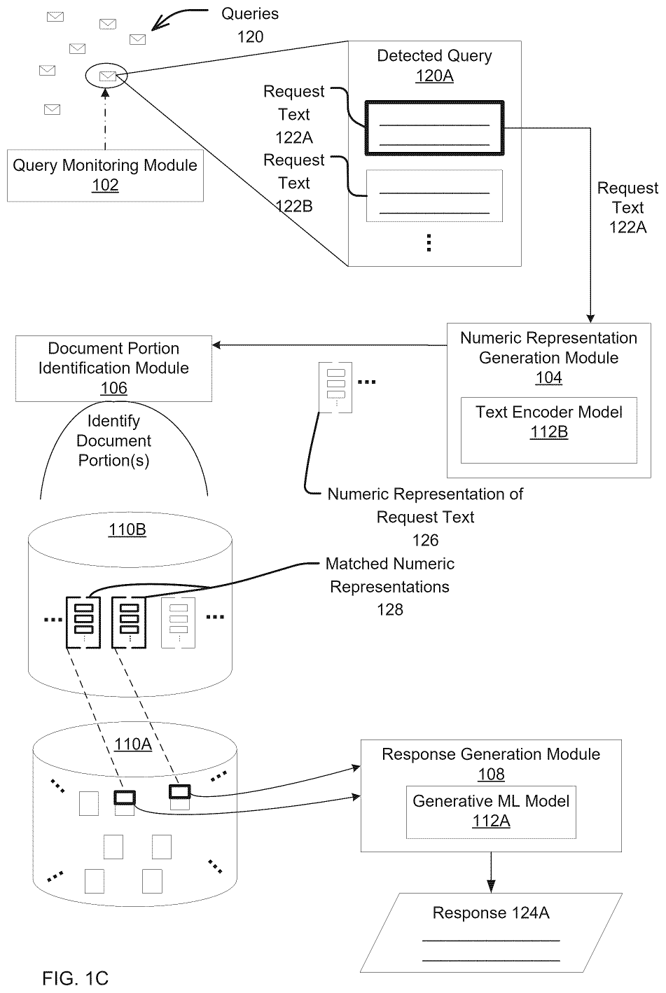

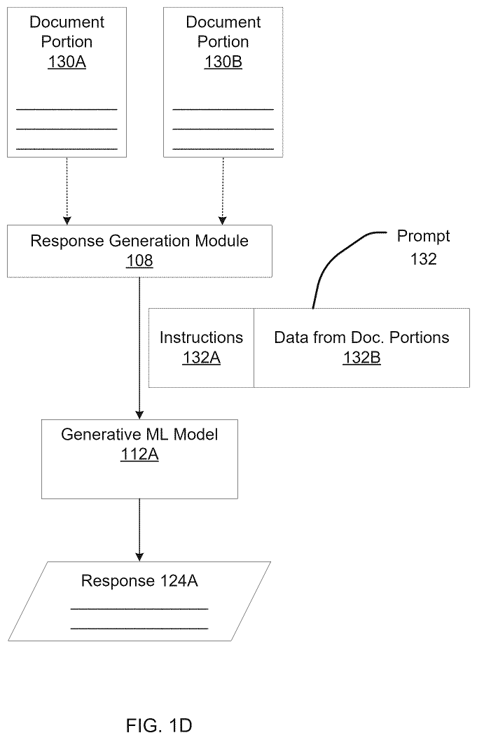

FIG. 1A illustrates an example interaction between a data processing system 100 and one or more health authority systems 150, according to some embodiments of the technology described herein. As shown in FIG. 1A, the data processing system 100 receives queries 100 (e.g., HAQs) from the health authority system(s) 150. Each of the queries 120 may include one or more requests for which the data processing system 100 is to generate a response. As an illustrative example, the health authority system(s) 150 may include a system of the federal food and drug administration (FDA) which transmits a HAQ to the data processing system 100 pertaining to a new drug application submitted with the FDA. The HAQ may include one or more requests for information about a drug (e.g., trial data, information about the chemical makeup of the drug, expected symptoms of the drug, and/or other information). The data processing system 100 may process the HAQ to generate response(s) to the request(s) for information about the drug.

As illustrated in FIG. 1A, the data processing system 100 generates responses 100 to requests in the queries 120. In the example embodiment of FIG. 1A, the data processing system 100 transmits the responses 124 to one or more devices 160. The responses 124 generated by the data processing system 124 may be used by user(s) of the device(s) 160 (e.g., subject matter experts) to generate finalized responses 134 that are transmitted to the health authority system(s) 150. For example, the responses 124 generated by the data processing system 100 may include textual data responding to the requests in the queries 120. The user(s) of the device(s) 160 may integrate the textual data into forms that are the finalized responses 134. For example, the user(s) may integrate the textual data into forms by copying and pasting the finalized responses 134 into a document (e.g., that are stored in a database). In some cases, the user(s) may modify the textual data of the responses 124 generated by the data processing system 100 (e.g., to correct errors, improve prose, and/or for other purposes). As another example, the user(s) of the device(s) 160 may review the responses 124 generated by the data processing system 100 and approve the responses 124. The finalized responses 134 may thus be responses 124 that have been approved by the user(s).

In some embodiments, the data processing system 100 may be configured to receive the queries 100 in different forms. For example, the data processing system 100 may receive the queries 120 as email communications. As another example, the data processing system 100 may receive the queries 120 as PDF files, plain text files, CSV files, webforms, and/or other suitable forms. In some embodiments, the data processing system 100 may be configured to extract requests from the queries 120. For example, the data processing system 100 may identify sections in a given query that each indicate a request. The data processing system 100 may extract text of a request from a respective section and process the text to generate a response to the request. A given query may include one or more requests. Thus, the data processing system 100 may be configured to generate one or more responses to the query to respond to the request(s) therein.

As indicated by the dashed outline of the device(s) 160 and the finalized responses 134, in some embodiments, the data processing system 100 may be configured bypass transmission of the responses to device(s) 160 for further processing to generate the finalized responses 134. The data processing system 100 may be configured to transmit the generated responses 124 to the health authority system(s) 150 without modification or approval by user(s) of the device(s) 160. In some embodiments, the data processing system 100 may be configured to transmit certain ones of responses 124 to the device(s) 160 (e.g., for user approval and/or modification) while bypassing the device(s) 160 for other ones of the responses 124. For example, the data processing system 100 may determine a confidence score associated with each of the responses 124. The data processing system 100 may transmit a response to a device for review by a user when its associated confidence score is less than a threshold confidence score and transmit the response directly to a health authority system when the confidence score is greater than the threshold confidence score.

Each of the health authority system(s) 150 may be a computer system of a regulatory health authority. For example, a health authority system may be a computer system of the FDA. As shown in FIG. 1A, the health authority system(s) 150 transmit queries 120 to the data processing system 100. Each of the queries 120 may include one or more requests for information that is to be provided by the data processing system 100. In some embodiments, the health authority system(s) 150 may be configured to transmit the queries 120 as email communications. For example, a health authority system may transmit a query to a particular email address (e.g., that is monitored by the data processing system 100). In some embodiments, the health authority system(s) 150 may be configured to transmit the queries 120 as documents (e.g., PDF documents). A query document may include multiple text sections associated with respective requests. For example, the query document may include a numbered list of requests. As another example, the query document may include a table in which each entry corresponds to a request.

FIG. 1B illustrates example components of the data processing system 100 of FIG. 1A, according to some embodiments of the technology described herein. The components interact with one another to generate the responses 124A, 124B, 124C, 12D to requests in the queries 120 received from the health authority system(s) 150. As shown in FIG. 1B, the data processing system 100 includes a query monitoring module 102, a numeric representation generation module 104, a document portion identification module 106, a response generation module 108, machine learning models 112, and one or more databases 110.

In some embodiments, the query monitoring module 102 may be configured to monitor one or more communication channels for receipt of the queries 120. In some embodiments, the query monitoring module 102 may be configured to monitor a storage location for receipt of a query through a communication network (e.g., the Internet). The query monitoring module 102 may monitor a storage location at which the data processing system 100 receives query communications. In some embodiments, the query monitoring module 102 may be configured to periodically check the storage location to determine whether any new queries have been received at the storage location. For example, the query monitoring module 102 may check the storage location every second, every hour, every day, or at another suitable frequency. In some embodiments, the storage location may be a storage location of a regulatory information management (RIM) system. The storage location may be designated in the RIM system for receipt of queries. For example, the storage location may be designated for receipt of HAQs from the health authority system(s) 150.

In some embodiments, the query monitoring module 102 may be configured to transform the queries 120 into a different form for further processing. The query monitoring module 102 may be configured to transform a query using a template specifying a particular format in which to organize requests of the query. For example, the template may specify how requests of the query are to be demarcated in the transformed query. The query monitoring module 102 may transmit segments of the query into respective sections of a template. In some embodiments, the query monitoring module 102 may be configured to transform a query comprising an email to obtain an email in a predefined format. The query monitoring module 102 may: (1) obtain information from the email query; and (2) transmit the information to respective fields in a second email that conforms to a predefined template. In some embodiments, a query (e.g., an email) may include multiple text sections that correspond to respective requests. The query monitoring module 102 may be configured to copy texts from sections of a query into respective sections of a transformed query (e.g., another document that conforms to a template). For example, the query monitoring module 102 may copy text from the multiple sections into multiple fields of an email that are demarcated (e.g., by numbering, spacing, delimiting character(s), and/or other formatting).

In some embodiments, the query monitoring module 102 may be configured to store a query and/or a transformation thereof in a datastore. In some embodiments, the datastore may be cloud based data storage. For example, the query monitoring module 102 may store an email specifying a query in cloud based storage encoded in the multipurpose Internet mail extension (MIME) format.

In some embodiments, the numeric representation generation module 104 may be configured to obtain a query from a datastore (e.g., a cloud based datastore in which the query was stored by the query monitoring module 102). The numeric representation generation module 104 may be configured to extract information from a query by reading textual data from the stored query. For example, the numeric representation generation module 104 may extract information from a stored email encoded in the Multipurpose Internet Mail Extensions (MIME) format by reading text from the email. In some embodiments, the numeric representation generation module 104 may be configured to: (1) identify information associated with multiple different requests in a query; and (2) extract information for each of the requests. For example, a query may include multiple text sections corresponding to different respective requests. The numeric representation generation module 104 may extract text from a text section for further processing of a respective request in the query. The numeric representation module 104 may be configured to extract text from a section by copying the text of the section.

In some embodiments, the numeric representation generation module 104 may be configured to generate numeric representations of requests included in the queries 120. The numeric representation generation module 104 may be configured to generate numeric representation(s) of each request in a query by: (1) extracting text in the query indicating the request; and (2) generating a numeric representation of the text in the query. In some embodiments, the numeric representation generation module 104 may be configured to generate the numeric representation of text in a query by encoding the text as the numeric representation. The numeric representation generation module 104 may be configured to use a text encoder model (e.g., text encoder model 112) to encode the text into the numeric representation. The numeric representation generation module 104 may be configured to provide the text as input to the text encoder model to obtain output that is the numeric representation of the text.

In some embodiments, the numeric representation generation module 140 may be configured to generate any suitable numeric representation of text in a query. For example, the numeric representation may be a vector storing numerical values, a matrix storing numerical values, a linked list storing numerical values, or another suitable numeric representation. Example embodiments described herein may use a vector as a numeric representation. However, this is for illustrative purposes as embodiments described herein may be configured to use another type of numeric representation in addition to or instead of a vector.

In some embodiments, the numeric representation generation module 104 may be configured to generate numeric representations of document portions. The numeric representation generation module 104 may be configured to: (1) access documents (e.g., from document database 110A); (2) divide the documents into portions; (3) generate a numeric representation of each of the document portions; and (4) store the numeric representations of the document portions (e.g., in numeric representation database 110B). The numeric representation generation module 104 may be configured to generate a numeric representation of a document portion by encoding text in the document portion into the numeric representation. The numeric representation generation module 104 may be configured to use a text encoder model (e.g., text encoder model 112B) to encode the text. The numeric representation generation module 104 may be configured to provide the text from the document portion as input to the text encoder model to obtain output that is the numeric representation of the text.

A document portion may be a subset of data from a document, or an entire document. For example, in some embodiments, the numeric representation generation module 104 may be configured to divide a document into portions that are less than a threshold size (e.g., a threshold number of characters, a threshold amount of memory, or another suitable threshold). If an entire document is less than the threshold size, then the entire document may be a document portion. If a document is greater than the threshold size, the numeric representation generation module 104 may divide the document into multiple portions.

In some embodiment, the document portion identification module 106 may be configured to identify, from among document portions stored in one or more databases (e.g., document database 110A), one or more document portions to use in responding to request(s) in a query. The document portion identification module 106 may be configured to identify document portion(s) to use for responding to a particular request using a numeric representation of the request. The document portion identification module 106 may be configured to compare the numeric representation of the request to respective numeric representations of document portions stored in a database (e.g., numeric representation database 110B). For example, the document portion identification module 106 may use an approximate k-nearest neighbor (kNN) algorithm to identify numeric representation(s) of document portion(s) that match the numeric representation of the request. As another example, the document portion identification module 106 may use a kNN algorithm to identify numeric representation(s) of document portion(s) that match the numeric representation of the request. In some embodiments, the document portion identification module 106 may be configured to identify document portion(s) associated with matched numeric representation(s). For example, the document portion identification module 106 may retrieve the document portion(s) from document database 110A (e.g., for use in generating a response to the request).

In some embodiments, the response generation module 108 may be configured to generate responses 124A, 124B, 124C, 124D to requests included in the queries 120 received from the health authority system(s) 150. In some embodiments, the response generation module 108 may be configured to generate a response to a request using a generative ML model (e.g., generative ML model 112A). The response generation module 108 may be configured to prompt the generative ML model for a response to the request. In some embodiments, the response generation module 108 may be configured to generate one or more prompts for the generative ML model using one or more document portions identified (e.g., by the document portion identification module 106) for use in generating a response to the request. For example, the content of the document portion(s) may be included as context in the prompt.

In some embodiments, the response generation module 108 may be configured to prompt the generative ML model with a series of prompts. For example, the response generation module 108 may prompt the generative ML model to identify past responses that may be related to a particular request for which a response is to be generated. The response generation module 108 may use the past response(s) in conjunction with identified document portion(s) to prompt the generative ML model to generate a response to the request. For example, the response generation module 108 may prompt the generative ML model to use the related previous response(s) and the identified document portion(s) to generate a response to the request.

As shown in FIG. 1B, in some embodiments, the data processing system 100 includes one or more databases 110. The database(s) 110 may comprise any suitable storage hardware. In some embodiments, the database(s) 110 may comprise one or more hard drives. For example, the database(s) 110 may comprise one or more hard disk drives and/or one or more solid state drives. In some embodiments, the database(s) 110 may comprise cloud-based data storage. In some embodiments, the database(s) 110 may be one or more distributed databases. Although in the example of FIG. 1B the database(s) 110 are shown as part of the data processing system 100, in some embodiments, the database(s) 110 may be separate from the data processing system 100 as indicated by the dashed lines around the database(s) 110. For example, the database(s) 110 may be cloud-based storage that is external to the data processing system 100. As another example, the database(s) 110 may be distributed across one or more datacenters external to the data processing system 100.

As shown in FIG. 1B, the database(s) 110 include a document database 110A. In some embodiments, the document database 110A may be configured to store documents that may be used for generating responses to requests in the queries 120 received by the data processing system 100. The documents stored in the document database 110A may, for example, include documents storing previously received queries, previously generated responses to requests in queries, regulatory standards, tables, trial data, new drug applications, protocols, and/or other information. In some embodiments, the document database 110A may be a regulatory information management (RIM) database. For example, the document database 110A may be a VEEVA RIM database. In some embodiments, the document database 110A may be a cloud-based database. For example, the database 110A may be an Amazon Web Services (AWS) S3 database. In some embodiments, the document database 110A may be configured to store metadata about the documents. For example, the document database 110A may include a database storing metadata. In one example implementation, the metadata database is a NoSQL database (e.g., a DynamoBD database).

In some embodiments, the document database 110A may be configured to store any suitable type of document. For example, the document database 110A may store PDF files, DOC files, DOCX files, CSV files, EXCEL files, scanned images of physical documents, and/or other documents.

As shown in FIG. 1B, the database(s) 110 include a numeric representation database 110B. The numeric representation database 110B may be configured to store numeric representations of document portions and numeric representations of requests from queries. For example, the numeric representation generation module 104 may be configured to store numeric representations generated by the module 104 in the numeric representation database 110B. The numeric representation database 110B may be searched (e.g., by the document portion identification module 106) to identify document portions to use in responding to requests in the queries 120. For example, the numeric representation database 110B may store vectors of numerical values each representing a respective portion of a document (e.g., from the document database 110A).

In some embodiments, the numeric representation database 110B may be periodically updated to capture numeric representations of documents in the document database 110A. For example, the numeric representation generation module 104 may periodically check the document database 110A for updates (e.g., addition of new documents and/or changes to previously stored documents) and generate numeric representations of portions of updated documents (e.g., new documents or changed documents). Accordingly, the numeric representation database 110B may store up-to-date numeric representations of portions of documents stored in the document database 110A.

As shown in FIG. 1B, the data processing system 100 includes machine learning models 112 that are used in processing queries. The machine learning models include a generative ML model 112A for use in generation of responses to requests in queries 120 and a text encoder model 112B for encoding request text and/or document portions into respective numeric representations. In some embodiments, the data processing system 100 may be configured to store parameters of the machine learning models 112 (e.g., learned through training). The data processing system 100 may be configured to use the stored parameters to determined outputs of the machine learning models 112. In some embodiments, one or more of the machine learning models 112 may be stored external to the data processing system 100. The data processing system 100 may be configured to communicate with an external system storing the machine learning model(s). For example, the data processing system 100 may transmit prompts to the external system to obtain outputs of the machine learning model(s).

In some embodiments, the generative ML model 112A may be a pre-trained generative ML model. In some embodiments, the generative ML model 112A may be a generative pre-trained transformer (GPT) model (e.g., a GPT model developed by OpenAI, FLAN-T5 model, or other GPT model). For example, the generative ML model 112A may be the GPT-4 model developed by OpenAI described in arXiv:2303.08774v6 [cs.CL] 4 Mar. 2024, which is incorporated by reference herein. As another example, the GPT model may be the GPT-40 model developed by OpenAI. The GPT model may have been pretrained using existing textual data (e.g., books, Internet website text, academic papers, and/or other textual data). The GPT model may include an encoder that generates a numerical representation of the input text. The encoder may include a vocabulary of words that the encoder uses to generate a numerical representation (e.g., a numerical vector) of each word in the input text. The GPT model may include an embedding layer that takes the numerical representation (e.g., a matrix) of the input text as input and generates an embedding having lower dimensionality than the input. In some embodiments, the GPT model may include a positional encoder that encodes information about a position of each word in the input text. The positional encoding may be combined with the embedding (e.g., by adding an embedding matrix and a positional encoding matrix). The GPT model may include multiple layers (e.g., attention layers and/or feed forward layers) that process a combination of the input text embedding and positional encoding. In some embodiments, the GPT model may include between 10-20 layers, 20-30 layers, 30-40 layers, 40-50 layers, 50-60 layers, 60-70 layers, 70-80 layers, 80-90 layers, 90-100 layers, 100-110 layers, 110-120 layers, 120-130 layers, 130-140 layers, or other suitable number of layers that are used to process the combination of the input text embedding and the positional encoding. The GPT model may decode the output of the layers to obtain an output. The output may be transformed into a word encoding which may be used to obtain output probabilities of various words (e.g., by applying a softmax function to the word encoding). The output probabilities of the words may be used to generate a final output of the model.

In some embodiments, the generative ML model 112A may be a pretrained model that has subsequently been tuned on previous queries and sets of requests included in the queries. The pretrained model may be tuned using training data comprising the previous queries and corresponding sets of requests. For example, the training data may include requests and corresponding responses. In some embodiments, the fine-tuning may be performed by applying a supervised learning technique to update parameters of the base pretrained model. For example, the fine-tuning may be performed by performing stochastic gradient descent to update parameters of the base pretrained model. The parameters may be updated by: (1) determining one or more requests detected by the model in a query; (2) comparing the one or more detected requests to a known set of requests in the query; and (3) updating the parameters of the model based on a difference between the request(s) detected by the model and the known set of requests. Accordingly, a base pretrained model may be fine-tuned for the task of generating responses to requests in HAQS.

In some embodiments, the text encoder model 112B may be an embedding model. The text encoder model 112B may be a text embedding model that is trained to embed a set of text into a respective numeric representation of the set of text. For example, the text embedding model may embed the set of text into a numerical vector of a particular dimension. The dimension of the vector may be a dimension in one of the following ranges: 10-100, 100-500, 500-1000, 1000-2000, 2000-3000, 3000-4000, 4000-5000, 5000-6000, or another suitable dimension. For example, the vector may be a 3072-dimensional vector. In some embodiments, the text encoder model 112B may be a neural network with multiple layers that encode text into its respective numeric representation. In some embodiments, the text encoder model 112B may be a GPT encoder trained to encode a set of text into a respective numeric representation. For example, the text encoder model 112B may be the text-embedding-3-large model developed by OpenAI. The text-embedding-3-large model may output a 3072-dimensional vector as the numeric representation of a respective input.

FIG. 1C illustrates processing of a query 120A by the data processing system 100 of FIGS. 1A-1B, according to some embodiments of the technology described herein.

As shown in FIG. 1C, the query monitoring module 102 detects a query 120A electronically received by the data processing system 100 (e.g., in an email communication). As shown in FIG. 1C, the detected query 120A includes multiple sets of text 122A, 122B that each indicate a respective request. The detected query 120A may include sections associated with other requests as indicated by the dotted lines in the detected query 120A.

As shown in FIG. 1C, the numeric representation generation module 104 may be configured to extract text 122A indicating a request (also referred to herein as “request text 122A”). The numeric representation generation module 104 uses the text encoder model 112B to generate a numeric representation 126 of the request text 122A. In the example of FIG. 1C, the numeric representation 126 of the request text 122A is a vector. As described herein, the numeric representation generation module 104 may be configured to generate another type of numeric representation of the request text 122A instead of a vector. A vector is used herein for illustrative purposes. In some embodiments, the numeric representation module 104 may be configured to process the request text 122A using the text encoder model 112B to generate the numeric representation. The numeric representation generation module 104 may be configured to process the request text 122A to generate the numeric representation 126 of the request text 122A by: (1) providing the request text 122A as input to the text encoder model 122B; and (2) obtaining output comprising the numeric representation 126 of the request text 122A. As an illustrative example, the numeric representation generation module 104 may provide the request text 122A as input to text-embedding-3-large model developed by OpenAI to obtain a 3072-dimensional vector as the numeric representation 126 of the request text 122A.

In some embodiments, the numeric representation generation module 104 may be configured to generate the numeric representation 126 of the request text 122A using a revised version of the request text 122A. The request text 122A may be converted into revised text (e.g., using the generative ML model 112A) and the numeric representation generation module 104 may generate the numeric representation 126 using the search string. For example, the generative ML model 112A may be prompted (e.g., by the response generation module 108) to convert the request text 122A into a search query. As another example, the request text 122A may be divided into multiple sets of text and the numeric representation generation module 104 may generate the numeric representation 126 using the multiple sets of text. In this example, the numeric representation 126 of the request text 122A may include multiple portions (e.g., multiple vectors corresponding to portions of the request text 122A). The generative ML model 112A may be prompted (e.g., by the response generation module 108) to divide the request text 122A into multiple portions to use for identification of document portions.

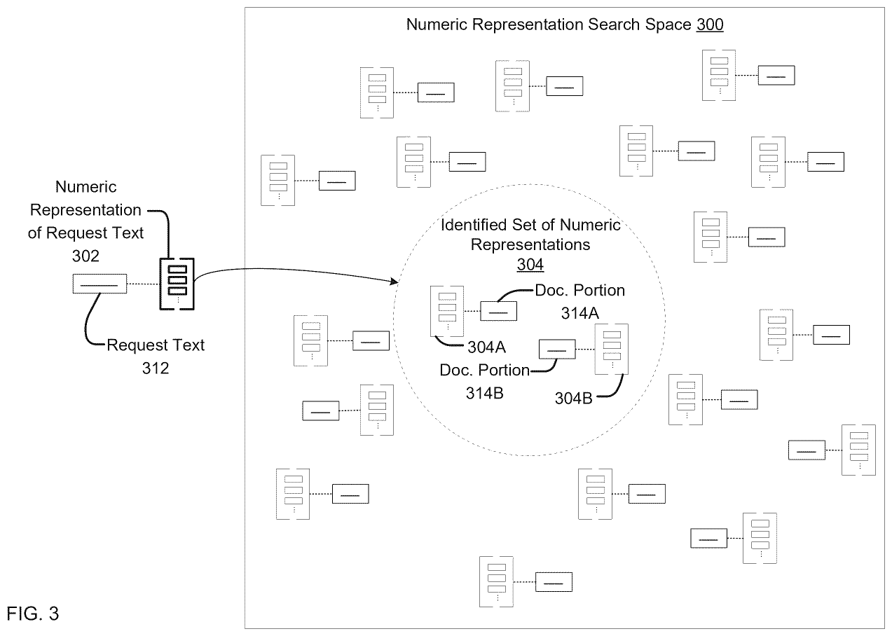

The document portion identification module 106 may be configured to use the numeric representation 126 of the request text 122A to identify document portion(s) to use in generating a response to the request indicated by the request text 122A. As shown in FIG. 1C, the document portion identification module 106 may be configured to identify the document portion(s) by matching the numeric representation 126 of the request text 122A to numeric representations 128 of respective document portions. In some embodiments, the document portion identification module 106 may be configured to match the numeric representation 126 of the request text 122A to the numeric representations 128 by performing a search in the database 110B storing numeric representations of document portions. Example techniques that the document portion identification module 106 may use to identify the document portion(s) are described herein with reference to FIG. 3.

In some embodiments, the document portion identification module 106 may be configured to identify document portion(s) for generating the response 124A by searching among a subset of documents and associated numeric representations. For example, the document portion identification module 106 may identify document portion(s) from among a filtered set of document portions using their associated numeric representations. In some embodiments, the filtered set of document portions may be obtained by: (1) receiving one or more filter criteria (e.g., from the generative ML model 112A); (2) applying the one or more filter criteria to the databases 110 to obtain a filtered set of documents and numeric representations of portions of the filtered set of documents; and (3) identifying the document portion(s) from the filtered set of documents using the numeric representations of portions of the filtered set of documents. For example, the one or more filter criteria may be based on request type, whether the request is clinical or non-clinical, whether the request is related to quality, whether the documents include previously received requests and corresponding responses, and/or other criteria.

Although in the example of FIG. 1C, the document portion identification module 106 is illustrated as performing a single search to identify document portion(s) for generating the response 124A, in some embodiments, the document portion identification module 106 may be configured to perform multiple searches. For example, the document portion identification module 106 may perform multiple searches on different sets of filtered documents to identify document portions from each of the sets of filtered documents. Accordingly, some embodiments may involve performing multiple searches to identify document portion(s) for generating the response 124A.

As shown in FIG. 1C, the response generation module 108 may be configured to use the document portions associated with the matched numeric representations 128 to generate a response 124A to the request indicated by the request text 122A. The response generation module 108 may be configured to generate the response 124A using the generative ML model 112A. The response generation module 108 may be configured to prompt the model using the document portions (e.g., by including the document portions as context) to obtain the response 124A.

FIG. 1D illustrates the generation, by the response generation module 108, of the response 124A to the request indicated by the request text 122A in the query 120A using a generative machine learning (ML) model, according to some embodiments of the technology described herein. As shown in FIG. 1D, the response generation module 108 obtains document portions 130A, 130B identified by the document portion identification module 106 (e.g., by matching the numeric representation 126 of the request text 122A to the numeric representations 128 of the document portions 130A, 130B).

As shown in FIG. 1D, the response generation module 108 may be configured to generate one or more prompts using the document portions 130A, 130B. In the example of FIG. 1D, the response generation module 108 generates a prompt 132 that includes instructions 132A to the generative ML model 112A and data 132B from the document portions 130A, 130B. In some embodiments, the response generation module 108 may be configured to include the data 132B from the document portions 130A, 130B as context for the instructions 132A. For example, the response generation module 108 may include, in the instructions 132A, instructions to generate a response to the request indicated by the request text 122A based on the data 132B from the document portions 130A, 130B. In some embodiments, the response generation module 108 may be configured to generate the prompt 132 by: (1) generating an initial prompt including the instructions 132A; and (2) appending the data 132B (e.g., text) from the document portions 130A, 130B to the initial prompt to obtain the prompt 132. The response generation module 108 may be configured to append the data 132B to the initial prompt using any suitable technique. For example, the response generation module 108 may append textual data from the document portions 130A, 130B to textual instructions.

As shown in FIG. 1D, the response generation module 108 may be configured to provide the generated prompt 132 as input to the generative ML model 112A. The generative ML model 112A provides the response 124A to the prompt 132. In some embodiments, the response 124A may include textual data responding to the request. In some embodiments, the response 124A may include citations to documents used in generating the response 124A.

In some embodiments, the response generation module 108 may be configured to use the generative ML model 112A to revise the request text 122A prior to generating the numeric representation 126 of the request text 122A. The response generation module 108 may be configured to prompt the generative ML model 112A to review the request text 122A and then trigger generation of the numeric representation 126 of the response text 122A (e.g., by the numeric representation generation module 104) and/or identification of the document portions 130A, 130B (e.g., by the document portion identification module 106). For example, the response generation module 108 may prompt the generative ML model 112A to convert the request text 122A into a document search query. As another example, the response generation module 108 may prompt the generative ML model 112A to generate multiple document search queries based on the request text 122A.

In some embodiments, the response generation module 108 may be configured to trigger identification of document portions (e.g., by the document portion identification module 106) in subsets of documents stored in the document database 110A. The response generation module 108 may be configured to apply a filter to documents in the document database 110A to obtain a subset of documents and identify document portions for generating a response from the subset of documents. For example, the response generation module 108 may apply a user-specified document filter, a filter based on request type (e.g., manufacturing/chemistry, manufacturing, and controls (CMC), clinical, labeling, safety/pharmacovigilance (PV), administrative, nonclinical, regulatory), a filter based on whether the request is clinical or non-clinical, a filter based on whether the request relates to quality, and/or a filter for documents that include previously received requests and corresponding responses.

Although in the example of FIG. 1D, the response generation module 108 is illustrated as generating a single prompt 132 for the generative ML model 112A to obtain the response 124A to the request indicated by the request text 122A, in some embodiments, the response generation module 108 may be configured to generate a series of prompts for the generative ML model 112A. For example, the response generation module 108 may be configured to prompt the generative ML model 112A to trigger generation of the numeric representation 126 of the request text 122A (e.g., by the numeric representation generation module 104). As another example, response generation module 108 may be configured to prompt the generative ML model 112A to trigger the identification of the document portions 130A, 130B (e.g., by the document portion identification module 106) one or more times (e.g., in different sets of filtered documents).

In some embodiments, the generative ML model 112A may be configured to trigger generation of the numeric representation 126 of the request text 122A and/or identification of the document portions 130A through an application program interface (API). In response to instructions in a prompt, the generative ML model 112A may issue an API call to trigger generation of the numeric representation 126 of the request text 122A (e.g., by the numeric representation generation module 104) and/or identification of document portions for responding to the request (e.g., by the document portion identification module 106). The numeric representation generation module 104 and/or the document portion identification module 106 may be configured to perform respective functions in response to the call from the generative ML model 112A. The generative ML model 112A may be configured to use output of the numeric representation module 104 and/or the document portion identification module 106 in generation of response. For example, the generative ML model 112A may: (1) receive a numeric representation of request text generated by the numeric representation generation module 104; (2) trigger identification of document portion(s) for generating a response by providing the numeric representation to the document portion identification module 106; (3) obtain document portion(s) identified by the document portion identification module 106; and (4) use the document portion(s) to generate a response.

Table 1 below illustrates an example series of prompts that may be generated by the response generation module 108 to generate the response 124A.

TABLE 1

| Prompt | Resulting Action |
|---|---|
| [Text Indicating Request] | Generative ML model receives text indicating request |
| [Optional Document Filter(s)] | and optional document filter(s) as input. |
| Assume the role of regulatory information | Generative ML model converts text indicating request |
| management specialist tasked with the goal of | into one or more document search queries. |
| identifying all the relevant documents that | |
| relate to the request. | |
| Convert the request into a precise document | |
| search query that encapsulates the question's | |
| essential intent keeping all keywords to | |
| enable semantic search. | |
| If the request is complex, please break down | |
| the question into smaller meaningful | |
| document search queries that can be used for | |
| semantic search. | |
| Always let the user know what document | |
| search queries you are searching with what | |
| filters in human-readable language, and | |
| always ensure all the document search queries | |
| are executed. | |
| First, perform a semantic search with the | Triggers generation of numeric representation of the |
| rephrased document search query via the | request text (e.g., by the numeric representation |
| search API, applying the document filter(s). | generation module 104) and identification of document |
| | portions for generating response (e.g., by the document |
| | portion identification module 106) based on specified |
| | document filter(s). |
| Next, execute the same document search via | Triggers identification of document portions storing |
| the search API this time applying the filter for | previously received requests and corresponding |
| classification as “Chemistry, manufacturing, | responses from the document database (e.g., by the |
| and controls (CMC) Response Documents.” If | document portion identification module 106). |
| it is a Quality question, then use filter for | |
| classification as “Non-CMC Response | |
| Documents” for non-clinical and clinical | |
| questions and don't apply any filter on vault | |
| or application for this step. | |
| Only draft a response once the document | Generative ML model generates an output in the |
| search queries are executed and you have | following format: |
| output results from the executed document | In response, we have conducted a thorough review of |
| search queries. | our nonclinical module for RSV BLA and Non-CMC |
| Synthesize the information retrieved from the | response documents for our past question. Based on |
| database, including data from relevant | our search, we can confirm [concise and structured |
| documents and past responses, to create a | details of findings and pertinent data points as tables to |
| comprehensive and informed reply to the | support the response]. |
| inquiry. | Document: [Document Name], Page: [Page Number], |
| The response should be clear, concise, and | URL: [Veeva URL] |
| directly address the specific question posed | Based on our historical questions and responses, our |
| and only respond with information retrieved. | responses in the past for questions similar to this has |
| Please don't use your own knowledge to | been [insert a structured and synthesized details of |
| respond to the question. | findings]. |
| If no document portions were retrieved, | We have noted the following areas where additional |
| clearly communicate about the failure in the | information may be pertinent to fully address your |
| search API call, and never draft a random | request: [list any gaps or further clarifications needed]. |
| response. | |
| Before listing similar past questions, include a | |
| reference that supports the current response. | |
| This reference should ideally point to the | |
| most relevant document(s) that substantiate | |
| your current response. | |
| After your current response, cite similar past | |
| questions and their responses to provide | |
| additional context and support. Perform this | |
| only if you have executed the document | |
| search query with filter classification as | |
| “CMC Response Documents”. Include | |
| references for each past question immediately | |
| following the summary and response. | |

As illustrated in the example of Table 1, the response generation module 108 first provides request text as input to the generative ML model. In some embodiments, the response generation module 108 may be configured to automatically provide the request text as input to the generative ML model. For example, the response generation module 108 may copy the request text to an input interface of the generative ML model. In some embodiments, the response generation module 108 may be configured to provide the request as input to the generative ML model by receiving input from a user copying the request text and pasting it into a graphical user interface (GUI) (e.g., a chatbot interface) of the generative ML model. The response generation module 108 further provides a document filter to apply to documents prior to searching (e.g., to limit the search space of document portions to the most relevant documents). The response generation module 108 prompts the generative ML model 112A to revise the response text into one or more document search queries. The response generation module 108 further prompts the generative ML model 112A to trigger multiple different searches using the one or more document search queries on different sets of filtered documents to identify document portions. The response generation module 108 then prompts the generative ML model 112A to generate a response using the identified document portion(s) with references citing documents used to generate the content of the response.

In some embodiments, the prompts transmitted to the generative ML model 112A may be automatically generated by the response generation module 108. For example, the response generation module 108 may be configured to generate prompts and provide them as input to the generative ML model 112A to generate a response. In some embodiments, the prompts transmitted to the generative ML model 112A may be generated by a user. For example, the user may enter the prompts through a graphical user interface (GUI). The prompts may be transmitted to the generative ML model 112A (e.g., in response to an input through the GUI). In some embodiments, the user may have a conversation with the generative ML model 112A through a chatbot interface through which the user can submit prompts to the generative ML model 112A and receive responses to the prompts. The example illustrated in Table 1 may be a series of communications between a user and the generative ML model 112A.

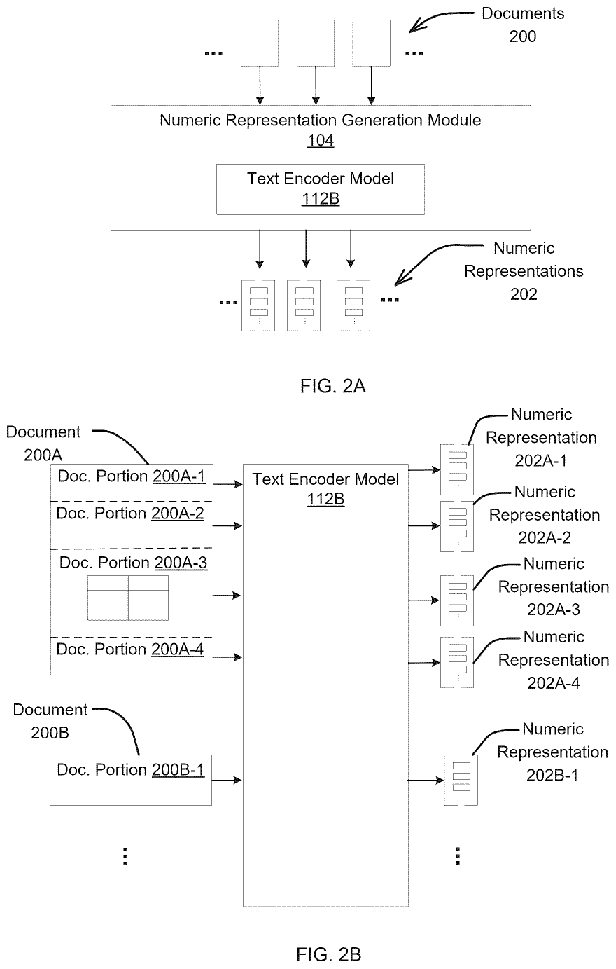

FIG. 2A illustrates generation of numeric representations 202 of portions of documents 200, according to some embodiments of the technology described herein. In some embodiments, the generation of numeric representations 202 may be performed by the numeric representation generation module 104 of the data processing system 100 of FIGS. 1A-1D to generate the numeric representations stored in the database 110B for identification of document portions to use in generating responses to requests. For example, the generation of numeric representations 202 may be performed to configure the data processing system 100 for performing retrieval augmented generation (RAG) of responses to the requests.

As shown in FIG. 2A, the numeric representation generation module 104 accesses documents 200. In some embodiments, the numeric representation generation module 104 may be configured to access the documents 200 by reading them from a database (e.g., document database 110A). For example, the numeric representation generation module 104 may periodically read the database 110A to identify new documents and/or identify new documents in response to a command (e.g., a user command). In some embodiments, the numeric representation generation module 104 may be configured to access the documents 200 by receiving them from external systems. The numeric representation generation module 104 may be configured to generate the numeric representations 202 in response to receiving the documents 200. Examples of numeric representations 202 that may be generated are described herein.

In some embodiment, the numeric representation generation module 104 may be configured to generate the numeric representations 202 using the text encoder model 112B described herein with reference to FIGS. 1A-1D. The numeric representation generation module 104 may be configured to provide portions of the documents 200 as input to the text encoder model 112B to obtain the numeric representations 202 of respective document portions. Example numeric representations that may be generated by the numeric representation generation module 104 are described herein with reference to FIGS. 1A-1D.

In some embodiments, the numeric representation generation module 104 may be configured to recognize text in the documents 200. The numeric representation generation module 104 may be configured to perform optical character recognition (OCR) to recognize text in the documents 200. For example, the numeric representation generation module 104 may perform OCR on PDF documents to recognize text therein. In some embodiments, the numeric representation generation module 104 may be configured to identify tables in the documents 200. For example, in a PDF document, the numeric representation generation module 104 may identify coordinates of the start and end of a table in the document. As another example, the numeric representation generation module 104 may identify a table in a DOCX file.

In some embodiments, the numeric representation generation module 104 may be configured to divide the documents 200 into portions (which may also be referred to as “chunks”). FIG. 2B illustrates dividing of documents 200A, 200B into respective portions and generation of numeric representations of the respective document portions, according to some embodiments of the technology described herein. As shown in FIG. 2B, the numeric representation generation module 104 divides the document 200A into document portions 200A-1, 200A-2, 200A-3, 200A-4. The numeric representation generation module 104 provides each of the portions 200A-1, 200A-2, 200A-3, 200A-4 or derivatives thereof as input to the text encoder model 112B to obtain respective numeric representations 202A-1, 202A-2, 202A-3, 202A-4. The numeric generation module 104 determines that all of the document 200B forms a single document portion 200B-1 (e.g., because it is below a maximum size). The numeric generation module 104 provides the document portion 200B-1 or a derivative thereof as input to the text encoder model 112B to obtain the respective numeric representation 202B-1.

In some embodiments, the numeric representation generation module 104 may be configured to divide the document into portion(s) by identifying headers in the document. The numeric representation generation module 104 may be configured to divide the document based on the headers. The numeric representation generation module 104 may be configured divide the document based on the headers by segmenting a section of the document that falls under each of the headers into one or more document portions.

In some embodiments, the numeric representation generation module 104 may be configured to: (1) identify a table in a document; and (2) segment the table as one or more document portions. This is illustrated in the example of FIG. 2B, in which the document 200A has been divided into portions including document portion 200A-3. The document portion 200A-3 is a table that was included in the document 200A. In some embodiments, the numeric representation generation module 104 may be configured to store a document portion comprising a table in any suitable format. For example, the numeric representation generation module 104 may save the document portion 200A-3 including the table in HTML format, as a CSV file, or another suitable format.

In some embodiments, the numeric representation generation module 104 may be configured to divide a document into portions that are greater than or equal to a minimum size. For example, the numeric representation generation module 104 may divide a document into portions that each have a minimum number of characters. The minimum number of characters may be a value between 10-50 characters, 50-100 characters, 100-150 characters, 150-200 characters, 200-250 characters, or another suitable minimum number characters. For example, the minimum number of characters may be 120 characters. The numeric representation generation module 104 may be configured to combine a document portion that is less than the minimum size with one or more other document portions to obtain a combined document portion that is greater than or equal to the minimum size. In some embodiments, the numeric representation generation module 104 may be configured to divide a document into portions that are each less than or equal to a maximum size. For example, the numeric representation generation module 104 may divide a document into portions that have less than or equal to a maximum number of characters. The maximum number of characters may be a value between 250-500 characters, 500-1000 characters, 1000-1500 characters, 1500-2000 characters, 2000-3000 characters, 3000-4000 characters, 4000-5000 characters, or another suitable maximum number of characters. For example, the maximum number of characters in a document portion may be 2000 characters. The numeric representation generation module 104 may be configured to divide a document portion that exceeds the maximum size into multiple smaller document portions. For example, the numeric representation generation module 104 may divide a section beneath a header that exceeds the maximum size into multiple document portions.

In some embodiments, the numeric representation generation module 104 may be configured to identify, in the documents, previously received requests and responses generated for the requests. The numeric representation generation module 104 may be configured to store a request and corresponding response as one or more document portions. For example, the numeric representation generation module 104 may store the request as text and the response as metadata. In some embodiments, the numeric representation generation module 104 may be configured identify requests and responses in the documents 200 by recognizing patterns associated with requests and responses. For example, the numeric representation generation module 104 may use regex expressions to recognize patterns associated with requests and responses. If a document does not satisfy any of the regex patterns, the numeric representation generation module may process the document by diving it into portions (e.g., based on maximum document size).

FIG. 3 illustrates an example identification of document portions to use for generating a response to a request in a query, according to some embodiments of the technology described herein. The illustrated identification of document portions may, for example, be performed by the document portion identification module 106 of data processing system 100 described herein with reference to FIGS. 1A-1D.

The system may be configured to identify document portion(s) for generating a response to a request by searching a numeric representation search space 300, as depicted in FIG. 3. The system may be configured to perform the search by comparing a numeric representation 302 of request text 312 to numeric representations of document portions in the numeric representation search space 300. In some embodiments, the system may be configured to compare the numeric representation 302 of the request text 312 to a numeric representation of a document portions by determining a measurement of similarity between the numeric representations. For example, the system may determine a measure of distance between the numeric representations. Examples measures of distance include Euclidean distance, cosine distance, Manhattan distance, Hamming distance, or another suitable measure of distance.

In some embodiments, the numeric representation search space 300 may include all numeric representations of portions of documents in a database (e.g., document database 110A). In some embodiments, the numeric representation search space 300 may include numeric representations of portions of a subset of documents in the database. For example, the subset of documents may be a filtered set of documents that meet one or more criteria (e.g., based on document type, time of creation, time of last update, type of request, and/or other factors).

As shown in FIG. 3, the system identifies a set of numeric representations 304 that are most similar to the numeric representation 302 of the request text 312. In some embodiments, the system may be configured to identify the set of numeric representations 304 by using any suitable search technique. The system may be configured to identify the set of numeric representations 304 by comparing the numeric representation 302 of the request text 312 to numeric representations of document portions (e.g., by measuring a measure of similarity between the numeric representations).

In some embodiments, the system may be configured to identify the set of numeric representation 304 by using a k-nearest neighbor (kNN) algorithm to identify the set 304 of the numeric representations that are most similar to the numeric representation 302 of the request text 312. The system may be configured to perform the kNN algorithm using a measure of similarity between the numeric representations. For example, where the numeric representations are vectors, the measure of similarity may be a measure of distance. Example measures of distance are described herein. The system may determine the measure of distance between the numeric representation 302 of the request text 312 and each of the numeric representations in the numeric representation search space 300. The system may select the set of numeric representations 304 based on distance measurements between the numeric representation 302 of the request text 312 and each of the numeric representations in the numeric representation search space 300. For example, the system may select a particular number of the closest the numeric representations. The number of selected numeric representations may be 1, 2, 3, 4, 5, 6, 7, 8, 9, or 10 closest numeric representations. As another example, the system may select the numeric representations that lie within a threshold distance of the numeric representation 302 of the request text 312.

In some embodiments, the system may be configured to identify the set of numeric representations 304 by using an approximate kNN (ANN) algorithm. The system may be configured to use the ANN algorithm to estimate a set of numeric representations that are most similar to the numeric representation 302 of the request text 312. For example, the ANN algorithm may perform a locality-sensitive hashing (LSH) based search, a best bin first search, or a balanced box-decomposition tree based search described in Arya, Sunil, et al. “An optimal algorithm for approximate nearest neighbor searching fixed dimensions.” Journal of the ACM (JACM) 45.6 (1998): 891-923, which is incorporated by reference herein. As another example, the ANN may perform a metric trees based search, a spill-trees based search, a defeatist search, or a hybrid sp-tree search described in Liu, Ting, et al. “An investigation of practical approximate nearest neighbor algorithms.” Advances in neural information processing systems 17 (2004), which is incorporated by reference herein. The ANN algorithm may estimate the most similar (e.g., the closest in distance) numeric representations to the numeric representation 302 of the request text 312 in the numeric representation search space 300. For example, the system may identify a particular number of estimated closest numeric representations. The number of numeric representations may be the 1, 2, 3, 4, 5, 6, 7, 8, 9, or 10 numeric representations.

In the example of FIG. 3, the identified set of numeric representation 304 includes numeric representation 304A of document portion 314A and numeric representation 304B of document portion 314B. Upon identifying the set of numeric representations 304, the system may retrieve the document portions 314A, 314B associated with the numeric representations 304A, 304B (e.g., to use for generating a response to the request indicated by the text 312). For example, the document portions 314A, 314B may be used by a generative ML model (e.g., generative ML model 112A) to generate a response (e.g., as described herein with reference to FIG. 1D).

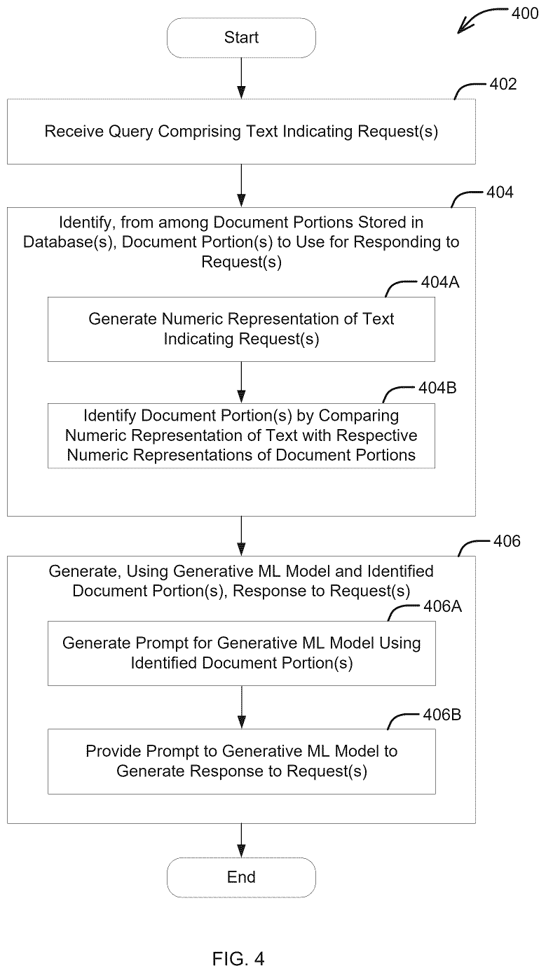

FIG. 4 is an example process 400 for processing queries (HAQs) received from a querying system (e.g., a health authority system), according to some embodiments of the technology described herein. Process 400 may be performed by any suitable computer system. For example, process 400 may be performed by data processing system 100 described herein with reference to FIGS. 1A-1D.

At block 402, the system performing process 400 receives a query (e.g., in an email communication) that includes text indicating one or more requests. In some embodiments, the system may be configured to identify, in the query, one or more text sections that each indicate a corresponding request. For example, the system may identify the text section(s) using numbers, headings, delimiting characters, and/or other delimiters in the query. The system may be configured to extract the text indicating the request(s). In some embodiments, the system may be configured to extract text of a particular request to generate a response to the request.

Next, process 400 proceeds to block 404, where the system identifies, from among document portions stored in one or more databases (e.g., database 110B described herein with reference to FIG. 1B), one or more document portions to use for responding to the request(s). As shown in FIG. 4, block 404 includes two sub-blocks 404A, 404B. In some embodiments, the steps of block 404 may be triggered based on prompts transmitted to a generative ML model (e.g., generative ML model 112A). For example, a prompt to search for document portion(s) may cause the generative ML model to make an API call that triggers identification of the document portion(s) to use for responding to the request(s).

At sub-block 404A, the system generates a numeric representation of the text indicating the request(s) (e.g., as described herein with reference to FIG. 1C). In some embodiments, the system may be configured to generate the numeric representation of the text indicating the request(s) using a text encoder model (e.g., text encoder model 112B described herein with reference to FIGS. 1A-1D). The system may provide the text as input to the text encoder model to obtain the numeric representation of the text as output from the text encoder model. For example, the system may provide the text as input to the text encoder model to obtain an output numerical vector as the numeric representation of the text indicating the request(s).

In some embodiments, the system may be configured to generate the numeric representation of the text by: (1) revising the text; and (2) generating the numeric representation using the revised text. The system may be configured to revise the text using a generative ML model (e.g., generative ML model 112A). For example, the system may prompt the generative ML model to generate one or more document search queries from the text indicating the request(s). The system may obtain the one or more document search queries and generate numeric representations using the one or more document search queries (e.g., by encoding the one or more document search queries into respective numeric representations (e.g., numerical vectors) using the text encoder model).

At sub-block 404B, the system identifies the document portion(s) by comparing the numeric representation of the text indicating the request(s) with respective numeric representations of the document portions stored in the database(s). In some embodiments, the numeric representations of the document portions may have been previously generated (e.g., by the system performing process 400 or another system). An example of how the numeric representations of the document portions is described herein with reference to FIGS. 2A-2B.

In some embodiments, the system may be configured to compare the numeric representation of the text indicating the request(s) to the respective numeric representations of the document portions by determining a measure of similarity (e.g., a measure of distance) between them. The system may be configured to use similarity measurements to identify one or more numeric representations that are most similar to the numeric representation of the text indicating the request(s). For example, the system may perform a KNN algorithm or an ANN algorithm to identify the set of numeric representation(s) of document portion(s). An example of how the system may identify the set of numeric representation(s) is described herein with reference to FIG. 3.

In some embodiments, the system may be configured to retrieve the identified document portion(s). The system may be configured retrieve the document portion(s) using an identified set of numeric representation(s) of the document portion(s) by: (1) identifying a document portion represented by each of the set of numeric representation(s) (e.g., identified from performing a search); and (2) retrieving the document portion from a database (e.g., document database 110A described herein with reference to FIG. 1B). For example, the system may read the document portion from a particular document.

In some embodiments, the system may be configured to perform one or more searches to identify the document portion(s). For example, the system may be configured to perform searches on one or more sets of documents (e.g., filtered set(s) of documents). The system may be configured to identify a set of documents (e.g., by applying a filter to a document database), and identify portions of the set of documents to use for generating a response (e.g., by comparing the numeric representation of the text indicating the request(s) with numeric representations of portions of documents in the set.

Next, process 400 proceeds to block 406, where the system generates, using a generative ML model (e.g. generative ML model 112A) and the identified document portion(s), a response to the request(s). As shown in FIG. 4, block 406 includes sub-blocks 406A, 406B.

At block 406A, the system generates a prompt for the generative ML model using the identified document portion(s). In some embodiments, the system may be configured to generate a prompt that includes instructions to generate an output response using data from the identified document portion(s). For example, the prompt may include the instructions and data from the identified document portion(s). The data from the identified document portion(s) may be appended to the instructions. The data from the identified document portion(s) may be used as contextual data that the generative ML model uses to generate a response to the request(s).

At block 406B, the system provides the prompt to the generative ML model to generate a response to the request(s). An example set of prompts that may be provided to the generative ML model to generate a response to a request is described herein with reference to Table 1. The system may be configured to transmit the prompt to the generative ML model. In some embodiments, the system may be configured to transmit, through a communication network to an external system hosting the generative ML model, the prompt. For example, the system may transmit the prompt through an API for communicating with the generative ML model. In some embodiments, the system may be configured to store parameters of the generative ML model and process the prompt using the parameters of the generative ML model.

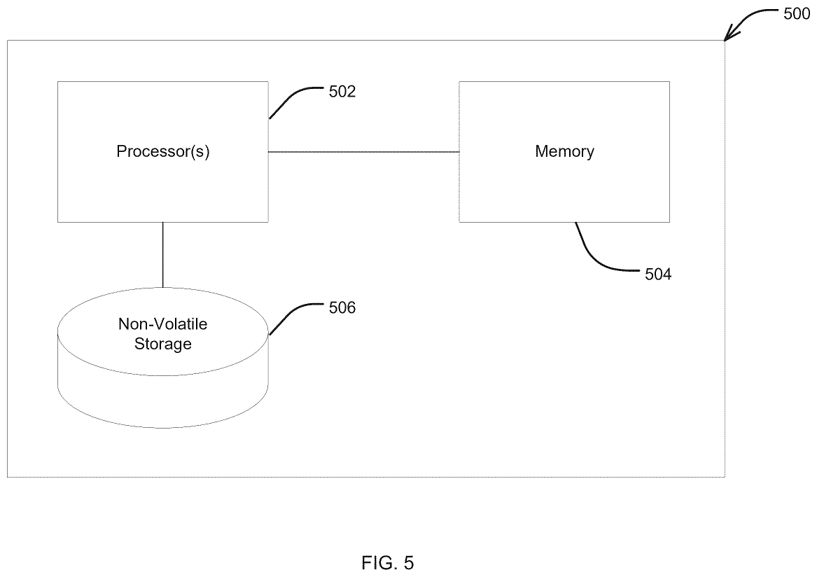

FIG. 5 is an example computer system 500 that may be used to implement some embodiments of the technology described herein. The computing device 500 may include one or more computer hardware processors 502 and non-transitory computer-readable storage media (e.g., memory 504 and one or more non-volatile storage 504). The processor(s) 502 may control writing data to and reading data from (1) the memory 504; and (2) the non-volatile storage device(s) 506. To perform any of the functionality described herein, the processor(s) 502 may execute one or more processor-executable instructions stored in one or more non-transitory computer-readable storage media (e.g., the memory 504), which may serve as non-transitory computer-readable storage media storing processor-executable instructions for execution by the processor(s) 502.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

### EXAMPLE EMBODIMENTS

In some embodiments, the techniques described herein relate to a method for processing health authority queries received from a health authority system, the method including: using at least one computer hardware processor of a data processing system to perform: (A) receiving a query through a communication channel, the query including text indicating at least one request; (B) identifying, from among document portions stored in at least one database, at least one document portion to use for responding to the at least one request, the identifying including: generating a numeric representation of the text in the query indicating the at least one request; identifying the at least one document portion by comparing the numeric representation of the text with respective numeric representations of document portions stored in the at least one database; and (C) generating, using a generative machine learning (ML) model and the identified at least one document portion, a response to the at least one request at least in part by: generating a prompt for the generative ML model using the identified at least one document portion; and providing the prompt to the generative ML model to generate the response to the at least one request.

In some embodiments, the techniques described herein relate to a system, wherein generating the prompt for the generative ML model using the identified at least one document portion includes: generating an initial prompt for the generative ML model; and generating the prompt by appending text from the identified at least one document portion to the initial prompt as context.

In some embodiments, the techniques described herein relate to a method, wherein the generative ML model includes a generative pre-trained transformer (GPT).

In some embodiments, the techniques described herein relate to a method, wherein identifying the at least one document portion by comparing the numeric representation of the text with respective numeric representations of document portions includes: identifying the at least one document portion using a k-nearest neighbors (kNN) algorithm.

In some embodiments, the techniques described herein relate to a method, wherein identifying the at least one document portion by comparing the numeric representation of the text with respective numeric representations of document portions includes: identifying the at least one document portion using an approximate k-nearest neighbors (kNN) algorithm.

In some embodiments, the techniques described herein relate to a method, wherein comparing the numeric representation of the text with respective numeric representations of document portions includes: determining a measure of distance between the numeric representation of the text and numeric representations of at least some of the document portions stored in the at least one database.

In some embodiments, the techniques described herein relate to a method, wherein the method further includes: transmitting the response to the at least one request to the health authority system.

In some embodiments, the techniques described herein relate to a method, wherein the method further includes: transmitting the response to the at least one request to one or more devices associated with one of more users for use in generating a query response.

In some embodiments, the techniques described herein relate to a method, wherein generating the numeric representation of the text in the query includes: applying a text encoder model to the text in the query or a derivative thereof to obtain the numeric representation of the text in the query.

In some embodiments, the techniques described herein relate to a method, wherein generating the numeric representation of the text in the query includes: revising the text in the query to obtain revised text, wherein applying the text encoder model to the text in the query or a derivative thereof includes applying the text encoder model to the revised text to obtain the numeric representation of the text in the query.

In some embodiments, the techniques described herein relate to a method, wherein revising the text in the query to obtain the revised text includes: generating another prompt for the generative ML model to revise the text in the query; and providing the other prompt to the generative ML model to obtain the revised text.

In some embodiments, the techniques described herein relate to a method, further including: accessing a plurality of documents; applying the text encoder model to portions of the plurality of documents to obtain the respective numeric representations of the document portions; and storing the respective numeric representations of the document portions in at least one database of the data processing system.

In some embodiments, the techniques described herein relate to a data processing system for processing healthy authority queries received from a health authority system, the data processing system including: at least one computer hardware processor; and at least one non-transitory computer-readable storage medium storing instructions, that when executed by the at least one computer hardware processor, cause the at least one computer hardware processor to perform: (A) receiving a query through a communication channel, the query including text indicating at least one request; (B) identifying, from among document portions stored in at least one database, at least one document portion to use for responding to the at least one request, the identifying including: generating a numeric representation of the text in the query indicating the at least one request; identifying the at least one document portion by comparing the numeric representation of the text with respective numeric representations of document portions stored in the at least one database; and (C) generating, using a generative machine learning (ML) model and the identified at least one document portion, a response to the at least one request at least in part by: generating a prompt for the generative ML model using the identified at least one document portion; and providing the prompt to the generative ML model to generate the response to the at least one request.

In some embodiments, the techniques described herein relate to a data processing system, wherein generating the prompt for the generative ML model using the identified at least one document portion includes: generating an initial prompt for the generative ML model; and generating the prompt by appending text from the identified at least one document portion to the initial prompt as context.

In some embodiments, the techniques described herein relate to a data processing system, wherein the generative ML model includes a generative pre-trained transformer (GPT).

In some embodiments, the techniques described herein relate to a data processing system, wherein comparing the numeric representation of the text with respective numeric representations of document portions includes: determining a measure of distance between the numeric representation of the text and numeric representations of at least some of the document portions stored in the at least one database.

In some embodiments, the techniques described herein relate to a data processing system, wherein generating the numeric representation of the text in the query includes: applying a text encoder model to the text in the query or a derivative thereof to obtain the numeric representation of the text in the query.

In some embodiments, the techniques described herein relate to a data processing system, wherein generating the numeric representation of the text in the query includes: revising the text in the query to obtain revised text, wherein applying the text encoder model to the text in the query or a derivative thereof includes applying the text encoder model to the revised text to obtain the numeric representation of the text in the query.

In some embodiments, the techniques described herein relate to a data processing system, wherein the instructions further cause the at least one computer hardware processor to perform: accessing a plurality of documents; applying the text encoder model to portions of the plurality of documents to obtain the respective numeric representations of the document portions; and storing the respective numeric representations of the document portions in at least one database of the data processing system.

In some embodiments, the techniques described herein relate to a non-transitory computer-readable storage medium storing instructions that, when executed by at least one computer hardware processor of a data processing system, cause the at least one computer hardware processor to perform a method for processing health authority queries received from a health authority system, the method including: (A) receiving a query through a communication channel, the query including text indicating at least one request; (B) identifying, from among document portions stored in at least one database, at least one document portion to use for responding to the at least one request, the identifying including: generating a numeric representation of the text in the query indicating the at least one request; identifying the at least one document portion by comparing the numeric representation of the text with respective numeric representations of document portions stored in the at least one database; and (C) generating, using a generative machine learning (ML) model and the identified at least one document portion, a response to the at least one request at least in part by: generating a prompt for the generative ML model using the identified at least one document portion; and providing the prompt to the generative ML model to generate the response to the at least one request.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method for processing health authority queries received from a health authority system, the method comprising:
using at least one computer hardware processor of a data processing system to perform:
(A) receiving a query through a communication channel, the query comprising text indicating at least one request;
(B) identifying, from among document portions stored in at least one database, at least one document portion to use for responding to the at least one request, the identifying comprising:
generating a numeric representation of the text in the query indicating the at least one request;
identifying the at least one document portion by comparing the numeric representation of the text with respective numeric representations of document portions stored in the at least one database; and
(C) generating, using a generative machine learning (ML) model and the identified at least one document portion, a response to the at least one request at least in part by:
generating a prompt for the generative ML model using the identified at least one document portion; and
providing the prompt to the generative ML model to generate the response to the at least one request.

2. The system of claim 1, wherein generating the prompt for the generative ML model using the identified at least one document portion comprises:
generating an initial prompt for the generative ML model; and
generating the prompt by appending text from the identified at least one document portion to the initial prompt as context.

3. The method of claim 1, wherein the generative ML model comprises a generative pre-trained transformer (GPT).

4. The method of claim 1, wherein identifying the at least one document portion by comparing the numeric representation of the text with respective numeric representations of document portions comprises:
identifying the at least one document portion using a k-nearest neighbors (kNN) algorithm.

5. The method of claim 1, wherein identifying the at least one document portion by comparing the numeric representation of the text with respective numeric representations of document portions comprises:
identifying the at least one document portion using an approximate k-nearest neighbors (kNN) algorithm.

6. The method of claim 1, wherein comparing the numeric representation of the text with respective numeric representations of document portions comprises:
determining a measure of distance between the numeric representation of the text and numeric representations of at least some of the document portions stored in the at least one database.

7. The method of claim 1, wherein the method further comprises:
transmitting the response to the at least one request to the health authority system.

8. The method of claim 1, wherein the method further comprises:
transmitting the response to the at least one request to one or more devices associated with one of more users for use in generating a query response.

9. The method of claim 1, wherein generating the numeric representation of the text in the query comprises:
applying a text encoder model to the text in the query or a derivative thereof to obtain the numeric representation of the text in the query.

10. The method of claim 9, wherein generating the numeric representation of the text in the query comprises:
revising the text in the query to obtain revised text, wherein applying the text encoder model to the text in the query or a derivative thereof comprises applying the text encoder model to the revised text to obtain the numeric representation of the text in the query.

11. The method of claim 10, wherein revising the text in the query to obtain the revised text comprises:
generating another prompt for the generative ML model to revise the text in the query; and
providing the other prompt to the generative ML model to obtain the revised text.

12. The method of claim 9, further comprising:
accessing a plurality of documents;
applying the text encoder model to portions of the plurality of documents to obtain the respective numeric representations of the document portions; and
storing the respective numeric representations of the document portions in at least one database of the data processing system.

13. A data processing system for processing healthy authority queries received from a health authority system, the data processing system comprising:
at least one computer hardware processor; and
at least one non-transitory computer-readable storage medium storing instructions, that when executed by the at least one computer hardware processor, cause the at least one computer hardware processor to perform:
(A) receiving a query through a communication channel, the query comprising text indicating at least one request;
(B) identifying, from among document portions stored in at least one database, at least one document portion to use for responding to the at least one request, the identifying comprising:
generating a numeric representation of the text in the query indicating the at least one request;
identifying the at least one document portion by comparing the numeric representation of the text with respective numeric representations of document portions stored in the at least one database; and
(C) generating, using a generative machine learning (ML) model and the identified at least one document portion, a response to the at least one request at least in part by:
generating a prompt for the generative ML model using the identified at least one document portion; and
providing the prompt to the generative ML model to generate the response to the at least one request.

14. The data processing system of claim 13, wherein generating the prompt for the generative ML model using the identified at least one document portion comprises:
generating an initial prompt for the generative ML model; and
generating the prompt by appending text from the identified at least one document portion to the initial prompt as context.

15. The data processing system of claim 13, wherein the generative ML model comprises a generative pre-trained transformer (GPT).

16. The data processing system of claim 13, wherein comparing the numeric representation of the text with respective numeric representations of document portions comprises:
determining a measure of distance between the numeric representation of the text and numeric representations of at least some of the document portions stored in the at least one database.

17. The data processing system of claim 13, wherein generating the numeric representation of the text in the query comprises:
applying a text encoder model to the text in the query or a derivative thereof to obtain the numeric representation of the text in the query.

18. The data processing system of claim 17, wherein generating the numeric representation of the text in the query comprises:
revising the text in the query to obtain revised text, wherein applying the text encoder model to the text in the query or a derivative thereof comprises applying the text encoder model to the revised text to obtain the numeric representation of the text in the query.

19. The data processing system of claim 17, wherein the instructions further cause the at least one computer hardware processor to perform:
accessing a plurality of documents;
applying the text encoder model to portions of the plurality of documents to obtain the respective numeric representations of the document portions; and
storing the respective numeric representations of the document portions in at least one database of the data processing system.

20. A non-transitory computer-readable storage medium storing instructions that, when executed by at least one computer hardware processor of a data processing system, cause the at least one computer hardware processor to perform a method for processing health authority queries received from a health authority system, the method comprising:
(A) receiving a query through a communication channel, the query comprising text indicating at least one request;
(B) identifying, from among document portions stored in at least one database, at least one document portion to use for responding to the at least one request, the identifying comprising:
generating a numeric representation of the text in the query indicating the at least one request;
identifying the at least one document portion by comparing the numeric representation of the text with respective numeric representations of document portions stored in the at least one database; and
(C) generating, using a generative machine learning (ML) model and the identified at least one document portion, a response to the at least one request at least in part by:
generating a prompt for the generative ML model using the identified at least one document portion; and
providing the prompt to the generative ML model to generate the response to the at least one request.
